(19) United States
(12) Patent Application Publication
(10) Pub. No.: US 2020/0272646 A1
(43) Pub. Date: Aug. 27, 2020

(54) ENTITY DEFINITION OVERRIDING FOR CLIENT APPLICATIONS

(71) Applicant: MZ IP HOLDINGS, LLC, Palo Alto, CA (US)

(72) Inventors: Matt Walsh, San Carlos, CA (US); David Redkey, Belmont, CA (US)

(21) Appl. No.: 16/778,174

(22) Filed: Jan. 31, 2020

Related U.S. Application Data
(60) Provisional application No. 62/808,903, filed on Feb. 22, 2019.

(51) Int. Cl. G06F 16/28; G06F 16/25; G06F 8/34; G06F 8/30

(52) U.S. Cl. CPC G06F 16/288; G06F 8/315; G06F 8/34; G06F 16/252

(57) ABSTRACT

Override parameters for one or more of default parameters of a virtual entity are received. The override parameters are applied to the one or more default parameters to generate a modified virtual entity. The modified virtual entity is caused to be instantiated in one or more client applications while the one or more client applications are running.

### CROSS-REFERENCE TO RELATED APPLICATIONS

This application claims the benefit of U.S. Provisional Patent Application No. 62/808,903, filed Feb. 22, 2019, the entire contents of which are incorporated by reference herein.

### BACKGROUND

Client applications, particularly games, often employ the concept of virtual entities, in which the software instantiates, retires or maintains some set of virtual entities that together form the software experience. For example, in a gaming application, the player can encounter virtual entities such as torches, characters, monsters, treasure chests, etc. When developing a client application, a developer writes custom, distinct code for each of these virtual entities of the client application. For example, the code for a torch may be completely separate from the code for a monster. In another example, the code for a red monster may be completely separate from the code for a blue monster. This may result in aspects that are in common between entities needing to be re-implemented for each of these entities in the client application.

### DESCRIPTION OF THE DRAWINGS

FIG. 1 is a schematic diagram of an example metric tracking system for tracking metrics of pools of units of a client application.

FIG. 2 is an illustration of an example of entity data for an entity to be utilized by one or more client applications, in accordance with embodiments of the disclosure.

FIG. 3 is an illustration of an example of modified entity data for a modified entity to be utilized by one or more client applications, in accordance with embodiments of the disclosure.

FIG. 4 is an illustration of an example of a user interface for receiving parameters for generating an entity, in accordance with embodiments of the disclosure.

FIG. 5A is an illustration of an example of an override parameter system receiving a query of generated entities, in accordance with embodiments of the disclosure.

FIG. 5B is an illustration of an example of an override parameter system generating results for a query, in accordance with embodiments of the disclosure.

FIG. 6 is a block diagram illustrating an example method of utilizing override parameters to generate a modified entity, in accordance with embodiments of the disclosure.

FIG. 7 is a block diagram of an example computing device.

### DETAILED :DESCRIPTION

Aspects of the disclosure relate to entity definition overriding for client applications. The client application may include various virtual entities (also referred to as “entities” hereafter). Entities may correspond to any unit/object represented within the client application (also referred to as “application” hereafter). For example, in a video game application, an entity may be a character, a monster, a chest, etc. instantiated within the virtual environment of the video game application.

In a conventional client application, each time a new entity is to be created, separate source code is written for each corresponding entity. For example, source code (also referred to as “code” hereafter) for a first entity is written and stored separately from source code for a second entity. This results in a large amount of data being required to store the code, as each of the entities has its own, distinct code. Additionally, because separate source code is written for each new entity, developing and instantiating a new entity within the client application requires a developer with intricate knowledge of the underlying source code to write the code for each new entity. Such a process is tedious, inefficient, and fraught with errors, particularly for client applications including a large number of entities. Furthermore, the modification of existing entities requires modifying the source code of the client application, which may introduce errors into the client application.

Aspects of the disclosure remedy the above and other deficiencies by creating/modifying entities of a client application by overriding parameters of existing entities of the client application. A parameter may be any property associated with an entity of a client application. For example, in a video game application, parameters of an entity may include a name, color, health, damage, size, model, etc. associated with the entity. In a client application, many entities may share one or more parameters with one another. For example, in a video game application, a red dragon and a blue dragon may have the same health, model, damage, etc. associated with each of these entities. Aspects of the disclosure leverage these similarities of parameters to efficiently create/modify entities of the client application and enable the instantiation of the new/modified entities in a client application while the client application is running.

Processing logic of a computer processing device may receive default parameters of a virtual entity. For example, in a video game application, the processing logic may receive default parameters for a wizard entity. Upon receipt of the default parameters, the processing logic may store the defaults parameters of the entity in a data structure. The data structure may include a listing of one or more entities and their corresponding parameters for use by one or more client applications. In some embodiments, each of the default parameters of each entity may be saved as a separate data file and the data structure may include a listing of one or more data tiles corresponding to the defaults parameters for one or more corresponding entities.

The processing logic may receive override parameters for one or more of the default parameters. In embodiments, an override parameter may be any modification of a default parameter of an entity. For example, if a default parameter for the color of a wizard entity is gray, an override parameter for the color of a wizard may be white. In some embodiments, an override parameter may be a new parameter to be added to the default parameters. For example, an override parameter may be a new parameter that enables a wizard entity to fly.

In embodiments, the override parameters may be provided via a simple script or user interface provided to a user. For example, if a user wanted to create a blue dragon entity, the user may enter/select an override parameter for the color blue to be applied to default parameters of a dragon. The default and override parameters may be linked to the properties/behaviors written in the underlying source code of the client application(s). For example, an override parameter that changes the color of a dragon to blue may be linked/mapped to the underlying source code of the client application(s) that applies the color blue to an entity. The result is the ability for a user with little to no knowledge of the source code of a client application to create/modify entities for use by the client application(s). This also prevents a user from having to modify the source code of a client application to create/modify an entity, preventing the introduction of any errors that may be produced by such modifications. Additionally, parameters may be linked to underlying source code of any number of client applications utilizing any number of different programming languages, providing an application agnostic process for creating/modifying, entities.

The processing logic may apply the override parameters to the one or more default parameters to generate a modified virtual entity. For example, if the override parameter was to change the color of a dragon (e.g., the entity associated with the default parameters) to blue, the processing logic may change the color parameter of the dragon to blue and generate a modified virtual entity (e.g., a blue dragon). In embodiments, upon generating the modified virtual entity, the processing logic may store the override parameters associated with the modified virtual entity in the data structure previously described.

The processing logic may cause the modified virtual entity to be instantiated in one or more client applications while the one or more client applications are running. For example, in a video game application, the processing logic may cause a modified virtual entity to be added (e.g., spawned) within the virtual environment of the video game application. Because the underlying source code of the client application has not been modified, the instantiation of the virtual entity in the client application(s) may be done without requiring the client application(s) to be restarted (e.g., while the client application(s) are running).

By utilizing similar parameters to create/modify entities, the amount of data required for each entity is reduced as separate source code for each entity is not required. Additionally, the utilization of override parameters allows for entities to be created/modified by users that do not have knowledge for the underlying source code of client application(s) and prevents such users from having to modify the source code of the client application(s). Furthermore, the override parameters may be linked to underlying source code of any number of client applications utilizing any number of programming languages, allowing for the creation/modification of entities across any number of client applications.

Although examples of the disclosure may be described in the context of a video game application, such examples are for illustrative purposes only. Aspects of the disclosure may be utilized by any client applications that use any kind of modeling environment and/or entities. For example, aspects of the disclosure may be used by architectural modeling software to generate modified architectural features, furniture, designs, etc. In another example, aspects of the disclosure may be used by computer animation and/or video editing software to efficiently create/modify entities between frames/scenes of a video. In a further example, aspects of the disclosure may be utilized by a mapping/navigation application to efficiently create/modify entities such as gas stations, restaurants, grocery stores, etc.

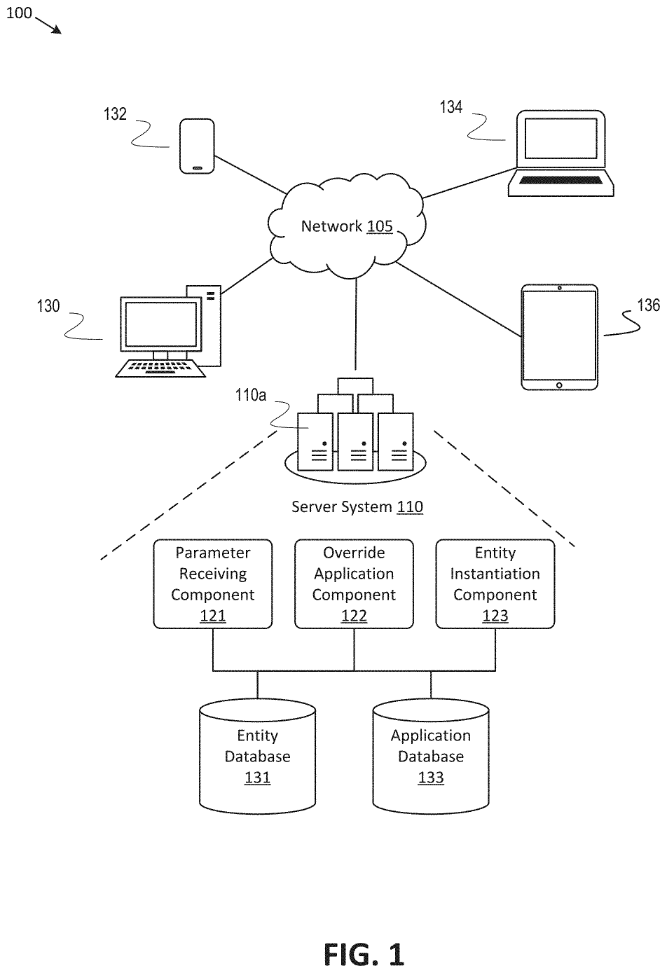

FIG. 1 is a schematic diagram of an example override parameter system 100 for applying override parameters to create/modify entities. A server system 110 including one or more servers 110a provides functionality for operating and managing an online application used by users via client devices 130-136, including installs of an online application (e.g., mobile application, gaming application, mobile gaming application), facilitating user interactions, introducing features, and any other suitable operation. The server system 110 includes software components and databases that can be deployed at one or more data centers in one or more geographic locations. In certain instances, the server system 110 is, includes, or utilizes a content delivery network (CDN). The server system 110 may include one or more software components, including a parameter receiving component 121, an override application component 122, an entity instantiation component 123, and any other suitable component for fulfilling the methods discussed herein. The software components can include subcomponents that can execute on the same or on different individual data processing apparatus. The server system 110 databases can include an entity database 131 and an application database 133, and any suitable number of other databases that are not illustrated in FIG. 1, such as a features database, a payments database, or an authentication database. The databases can reside in one or more physical storage systems. The software components and data will be further described below.

A client application, such as a web-based application, can be provided as an end-user application to allow users to interact with the server system 110 and with other users of the server system 110 via the application. The client application or components thereof can be accessed through a network 105 (e.g., the Internet) by users of client devices, such as a personal computer 130, a smart phone 132, a laptop computer 134, or a tablet computer 136. Other client devices are possible. Additionally, or alternatively, software components for the system 100 (e.g., the parameter receiving component 121, the override application component 122, the entity instantiation component 123) or any portions thereof can reside on or be used to perform operations on one or more client devices.

The override parameter system 100 includes the parameter receiving component 121, the override application component 122, and the entity instantiation component 123 as being able to communicate with the entity database 131 and the application database 133. The entity database 131 may include one or more data structures storing one or more entities and their associated parameters for use by one or more client applications by the override parameter system 100, such as default parameters, override parameters, entity archetypes, entity names, key values, etc. of entities. The application database 133 may include information about one or more client applications utilizing the entities of the override parameter system 100. Such information may include client application identifiers, addresses, programming languages, linking/mapping information to underlying source code of the client application(s), and/or any other suitable information.

The parameter receiving component 121 may be responsible for receiving default parameters and/or override parameters for entities. The parameter receiving component 121 may be implemented by one or more human operators, or may be implemented as a machine-learning, model that automatically performs one or more of the actions discussed herein. In embodiments, the parameter receiving component 121 may generate a simple script or user interface and provide the script/user interface to a user to facilitate the generation of the default parameters and/or override parameters. For example, the parameter receiving component 121 may generate a user interface that includes a listing of one or more parameters of an entity and provide the user interface to a client device of a user. The parameter receiving component 121 may receive the default parameters/override parameters that are entered/selected by the user via the user interface.

The override application component 122 may be responsible for applying override parameters received by parameter receiving component 121. The override application component 122 may receive one or more override parameters from the parameter receiving component 121 that are to be applied to one or more corresponding default parameters of an entity. For example, the override application component may receive an override parameter corresponding to the color blue that is to be applied to the default parameters of a dragon entity. The override application component 122 may identify the default parameters stored in a data structure at the entity database 131. For example, the override application component 122 may identify the default parameters for a dragon entity within the data structure. Upon identifying the default parameters, the override application component 122 may apply the override parameters to the default parameters to generate a modified entity. For example, the override application component 122 may apply the override parameter of the color blue to the default parameters of a dragon entity to generate a modified entity (e.g., a blue dragon). In embodiments, the override application component 122 may store the override parameters associated with the modified entity in the data structure at entity database 131. In some embodiments, the override application component 122 may generate a new data file that includes the override parameters associated with the modified entity.

The entity instantiation component 123 may be responsible for instantiating new/modified entities generated by the override application component 122 in one or more client applications. As previously described, the override parameters/default parameters may be linked/mapped to underlying source code/data files of the client application(s). In embodiments, the entity instantiation component 123 may identify the mapping information for the underlying source code/data files in the application database 133. For example, the entity instantiation component 123 may identify mapping information for the underlying source code that applies the color blue to an entity based on receiving an override parameter corresponding to the color blue. In some embodiments, the mapping information may include one or more data files or other internal reference/identifier used by the client application(s) that correspond to the override parameter.

The entity instantiation component 1.23 may cause one or more client applications to instantiate the new/modified entities. In embodiments, the entity instantiation component 123 may transmit a command to the one or more client applications to cause the instantiation of a new/modified entity. The command may include information identifying the underlying source code/data files corresponding to the defaults parameters and/or override parameters associated with the new/modified entity. Upon receipt of the command, the one or more client applications may instantiate the new/modified entities while the one or more client applications are running. For example, upon receipt of the command a video game application may add (e.g., spawn) the new/modified entity within the virtual environment of the video game application while the video game application is running (e.g., without requiring a restart of the application).

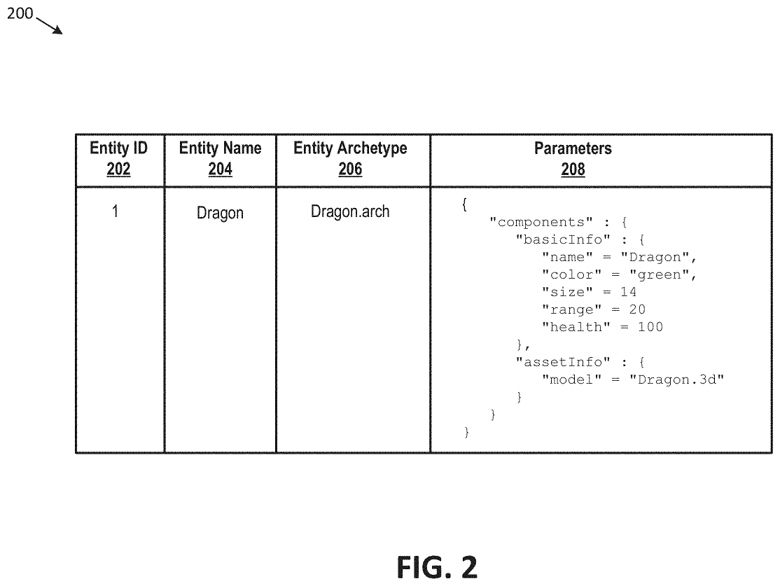

FIG. 2 is an illustration of an example of entity data 200 for an entity to be utilized by one or more client applications, in accordance with embodiments of the disclosure. In embodiments, entity data 200 may correspond to an entry in a data structure that includes a listing of one or more entities, as previously described. In some embodiments, entity data 200 may correspond to a data file for an entity.

Referring to FIG. 2, entity data 200 may include an entity identification (ID) 202, an entity name 204, an entity archetype 206, and parameters 208. The entity ID 202 may correspond to a reference/identification for the entity associated with entity data 200. The entity ID 202 may be a number, a series of alphanumeric characters, or any other type of reference/identification. In embodiments, entity ID 202 may correspond to a key value of a key value store. In some embodiments, the entity ID 202 may be utilized for internal representation by client application(s) and/or cross-referencing between different entities. For example, in a video game application, a room entity might include entity ID 202 (e.g., 1) to indicate that the room is to have a dragon inside of it. The entity name 204 may be a name that is assigned to a particular entity. The entity name 204 may be specified to be provided to a user and be more human-friendly.

The entity archetype 206 may be a name/data file for the archetype of a particular entity. The entity archetype 206 may be associated with the default parameters for a particular entity type. Different modified entities that are similar with one another may each apply different override parameters to the same entity archetype 206. For example, red dragons, blue dragons, black dragons, etc. may apply different override parameters to the same archetype (e.g., dragon.arch).

Parameters 208 may correspond to parameters associated with the entity associated with entity data 200. For example, parameters 208 may correspond to the default parameters for a dragon entity within a video game application. Parameters 208 are shown in a simple script format that includes a listing of the default parameters for a dragon entity. For example, a dragon entity may be named “Dragon,” be green in color, have a size value of 14, a range value of 20, a health value of 100, and use a unit model titled “Dragon.3d”. As previously described, the parameters 208 may be mapped/linked to underlying code/data files of one or more client applications to enable the one or more client applications to instantiate the entity.

It should be noted that entity ID 202, entity name 204, entity archetype 206, and parameters 208 are shown for illustrative purposes only. In embodiments, entity data 200 may include any combination of entity ID 202, entity name 204, entity archetype 206, parameters 208 and/or any other information that may be utilized to generate an entity.

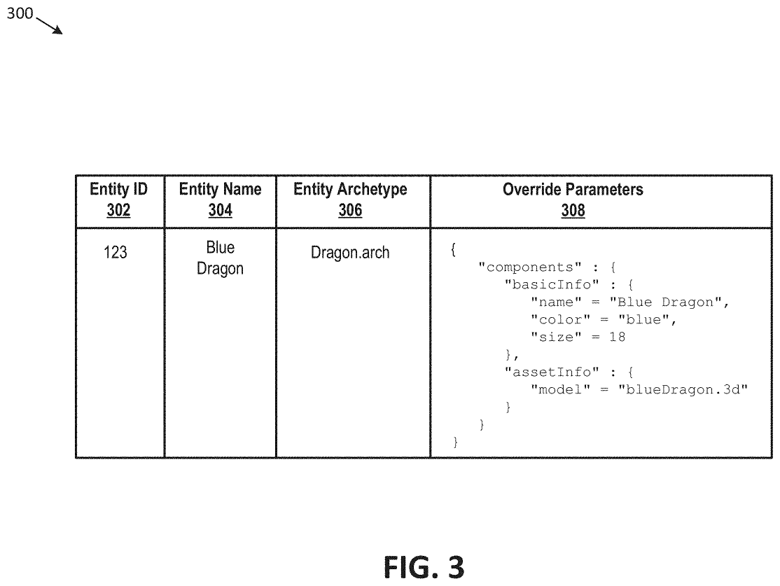

FIG. 3 is an illustration of an example of modified entity data 300 for a modified entity to be utilized by one or more client applications, in accordance with embodiments of the disclosure. Modified entity data 300 may correspond to a data entry or data file used to generate a modified entity. The modified entity data 300 may include entity ID 302, entity name 304, and entity archetype 306, as previously described at FIG. 2. The modified entity data 300 may include override parameters 308 that correspond to override parameters to be applied to default parameters of an entity to generate the modified entity.

Referring to FIG. 3, the modified entity data 300 corresponds to the generation of a blue dragon entity. The blue dragon entity may be generated by applying override parameters 308 to the default parameters (e.g., parameters 208) of the dragon entity archetype 306 (e.g., dragon.arch). Accordingly, when generating the blue dragon, the default parameters of the dragon archetype may be overridden with override parameters 308. For example, when generating the blue dragon modified entity, parameters 208 may be overridden so that the name is changed from “Dragon” to “Blue Dragon,” the color is changed from green to blue, and the size is changed from 14 to 18. If one of the default parameters does not have a corresponding override parameter 308, then the default parameter for the entity archetype 306 may be used. For example, when generating the blue dragon modified entity, the default parameters of a range value of 20 and a health value of 100 (from parameters 208) may be used.

In some embodiments, override parameters 308 may include a new parameter to be added to the default parameters when generating the modified entity. A new parameter may be any parameter not included in the default parameters for an entity. For example, override parameters for a blue dragon may include a new parameter that enables the blue dragon to fly, as is shown in the sample script below:

```
{
  “entityArchetypeCode” : “dragon.arch”,
  “components” : {
    “basicInfo” : {
      “name” = “Blue Dragon”,
      “color” = “blue”,
      “size” = 18,
      “canFly” = true
    },
    “assetInfo” : {
      “model” = “blueDragon.3d”
```

It should be noted that entity ID 302, entity name 304, entity archetype 306, and parameters 308 are shown for illustrative purposes only. In embodiments, modified entity data 300 may include any combination of entity ID 302, entity name 304, entity archetype 306, parameters 308 and/or any other information that may be utilized to generate a modified entity.

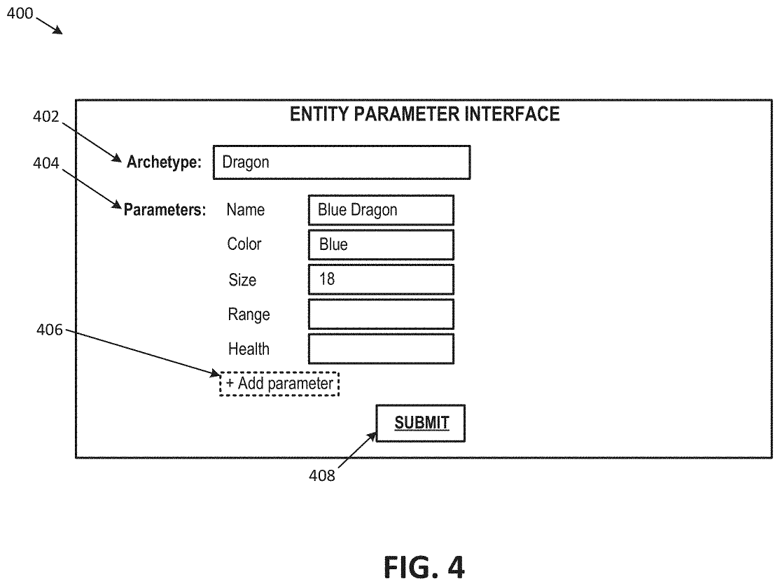

FIG. 4 is an illustration of an example of a user interface 400 for receiving parameters for generating an entity, in accordance with embodiments of the disclosure. As previously, described, in some embodiments the override parameter system may provide a user interface 400 to a user to facilitate the entry of one or more default parameters/override parameters to be used for the generation of an entity/modified entity. In some embodiments, the user interface 400 may, be a graphical user interface (GUI). In embodiments, the user interface 400 may be provided to a client device associated with the user.

The user interface may include an archetype 402 associated with the entity, parameters 404 associated with the entity, an add parameter 406 option and a submission icon 408. When generating default parameters for an entity, a user may enter a name for the archetype 402. For example, when generating default parameters for a dragon entity, the user may enter “Dragon” as the archetype 402 via the user interface. The user may then add parameters that are to be used as the default parameters for the entity by selecting the add parameter 406 icon. For example, a user may add the Name, Color, Size, Range, and Health parameters as the default parameters for a dragon entity. In some embodiments, the parameters 404 may be pre-populated with one or more parameters. For example, the parameters 404 may be pre-populated with the Name, Color, and Size parameters. The user may enter or select corresponding alphanumerical values that correspond to the desired default parameters for the entity. For example, the user may enter “Dragon” under the name parameter, green under the color parameter, 14 under the size parameter, 20 under the range parameter, and 100 under the health parameter to indicated the default parameters for the dragon archetype, as previously described at FIG. 2. The user may then select the submission icon 408 to provide the default parameters for generating the entity to the override parameter system.

When generating override parameters to be used to generate a modified entity, a user may either enter an existing archetype 402 or select an archetype 402 from a listing of existing archetypes via the user interface 400. Upon entering/selecting an archetype 402, the parameters 404 portion of the user interface 400 may be populated with the default parameters for the entered/selected archetype 402. For example, upon selecting the dragon archetype, the parameters 404 portion of the user interface 400 may be populated with the default parameters of the dragon archetype (e.g., Name, Color, Size, Range, and Health).

In some embodiments, a user may enter the new override parameters via the user interface 400. For example, the user may enter the Name for the modified entity as “Blue Dragon,” the color of the modified entity as blue and the size value of the modified entity as 18. In embodiments, the user interface 400 may provide a listing and/or graphical representation of options that are available to use as override parameters. For example, upon selecting the color parameter, the user interface 400 may provide a listing of colors and/or a color wheel indicating the available colors that may be entered as an override parameter for the modified entity.

In embodiments, the user interface may include an add parameter 406 option that enables a user to add a new parameter to the modified entity, as previously described. For example, the ability to fly may be added as a new parameter for the Blue Dragon modified entity. Once the values for the override parameters have been entered via the user interface 400, the user may then select the submission icon 408 to provide the override parameters for generating the modified entity to the override parameter system. In embodiments, the user interface 400 may perform suitable type checking or other parameter validation checks on entered values to ensure that the entered values are valid for each parameter field. Such parameter validation checks can be performed as the parameters are entered by a user and/or when the submission icon 408 is selected. For purposes of illustration and not limitation, such parameter validation checks could notify the user that the color “blue” is not a valid entry for the “Size” parameter field, and that the size “18” is not a valid entry for the “Color” parameter field. Other such parameter validation checks are possible, and will depend on the specified type and allowable values, ranges, etc. of each parameter.

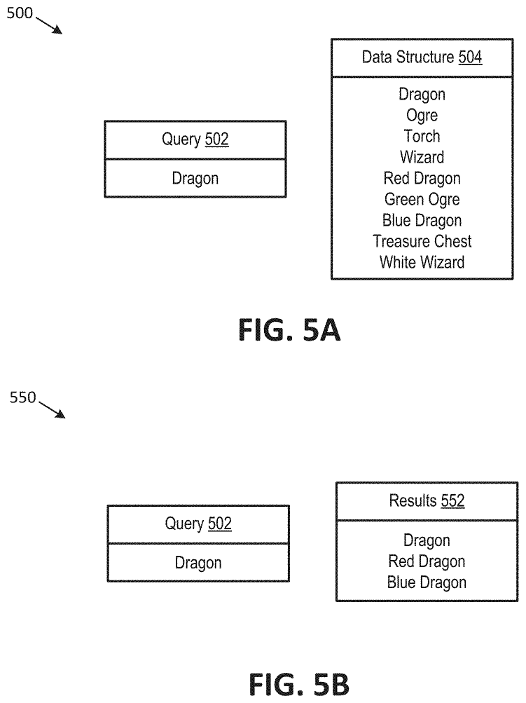

FIG. 5A is an illustration of an example of an override parameter system 500 receiving a query of generated entities, in accordance with embodiments of the disclosure. In some embodiments, the override parameter system 500 may include searching functionality to search a data structure 504 that includes a listing of archetypes/entities/modified entities in response to receiving a query 502 including one or more search criteria. In embodiments, the query 502 may be received from a client device of a user. A user wishing to generate an entity/modified entity may not be aware of what archetypes/entities/modified entities already exist in the override parameter system 500. For example, a user may wish to generate a new, gold dragon entity for use by one or more client applications, but may not be aware of what dragon entities already exist in the override parameter system 500 (or if the gold dragon entity already exists). To determine what dragon entities, if any, already exist in the override parameter system 500, the user may transmit a query 502 to the override parameter system 500 including a search criterion for all the entities in the data structure 504 that are associated with dragons. In embodiments, multiple search criteria may be used for a query 502. For example, the user may transmit a query 502 that includes a first search criterion for dragons and a second search criterion for flying to determine what flying dragon entities exist in the data structure 504 of the override parameter system 500.

FIG. 5B is an illustration of an example of an override parameter system 550 generating results for a query, in accordance with embodiments of the disclosure. Upon receiving the query 502, the override parameter system 550 may attempt to identify one or more archetypes/entities/modified entities in data structure 504 that satisfy the search criteria of the query 502. For example, the override parameter system 550 may attempt to identify one or more archetypes/entities/modified entities in data structure 504 that are associated with dragons. Upon identifying the one or more archetypes/entities/modified entities in data structure 504 that satisfy the search criteria of query 502, the override parameter system 550 may generate the results 552 of the query 502. The results 552 may be a listing or other representation of the one or more identified archetypes/entities/modified entities in data structure 504 that satisfy the search criteria. Upon generating the results 552, the override parameter system 550 may transmit the results 552 to the client device that submitted the query 502.

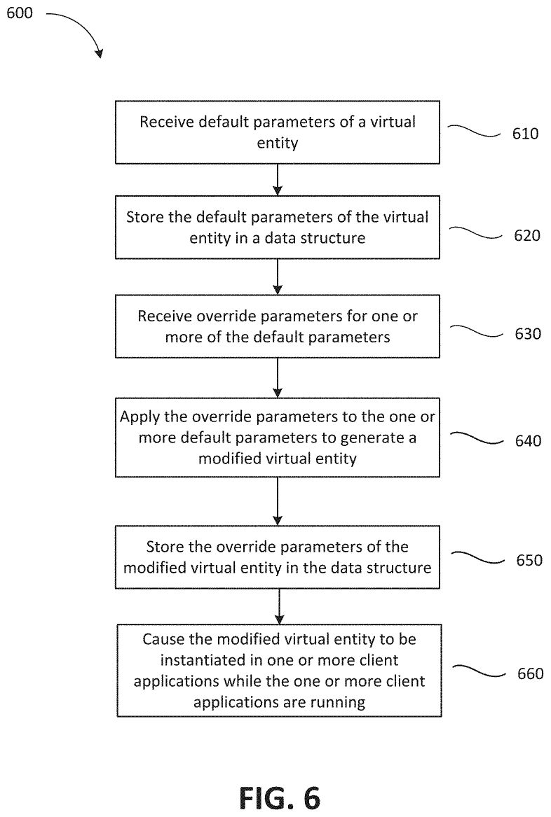

FIG. 6 is a block diagram illustrating an example method 600 of utilizing override parameters to generate a modified entity, in accordance with embodiments of the disclosure. In general, the method 600 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as parameter receiving component 121, override application component 1.22 and/or entity instantiation component 123.

Method 600 may begin at block 610, where the processing logic receives default parameters of a virtual entity. In embodiments, the default parameters may be utilized to instantiate the virtual entity in one or more client applications. In embodiments, the one or more client applications may be video game applications. In some embodiments, the one or more client applications may be architectural modeling applications. In an embodiment, the one or more client applications may be computer animation and/or video editing applications. In embodiments, the one or more client applications may be mapping/navigation applications. In some embodiments, the one or more client applications may include a first application using a first programming language and a second application using a second programming language. For example, the one or more client applications may include a first client application using C++ and a second client application using Lua™.

At block 620, the processing logic stores the default parameters of the virtual entity in a data structure. As previously described, the data structure may include a listing of one or more archetypes/entities/modified entities. In some embodiments, the data structure may include the default parameters/override parameters associated with each of the one or more archetypes/entities/modified entities. In other embodiments, each of the default parameters/override parameters may be stored as separate data files. In some embodiments, the data structure may be a key value store that uses an array of keys, where each key is associated with a different archetype/entity/modified entity of the data structure.

At block 630, the processing logic receives override parameters for one or more of the default parameters. In some embodiments, the processing logic may receive the override parameters from a client device of a user. In embodiments, the processing logic may receive the override parameters via a simple script and/or user interface that facilitates the generation of the override parameters by the user.

At block 640, the processing logic applies the override parameters to the one or more default parameters to generate a modified virtual entity. As previously described, the processing logic may apply the override parameters to the one or more default parameters and generate the modified virtual entity without modifying the underlying source code of the one or more client applications.

At block 650, the processing logic stores the override parameters of the modified virtual entity in the data structure.

At block 660, the processing logic causes the modified virtual entity to be instantiated in one or more client applications while the one or more client applications are running. Because the modified entity is generated without modifying the underlying source code of the one or more client applications, the modified entity may be instantiated in the one or more client applications while the one or more client applications are running (e.g., without requiring the one or more client applications to restart).

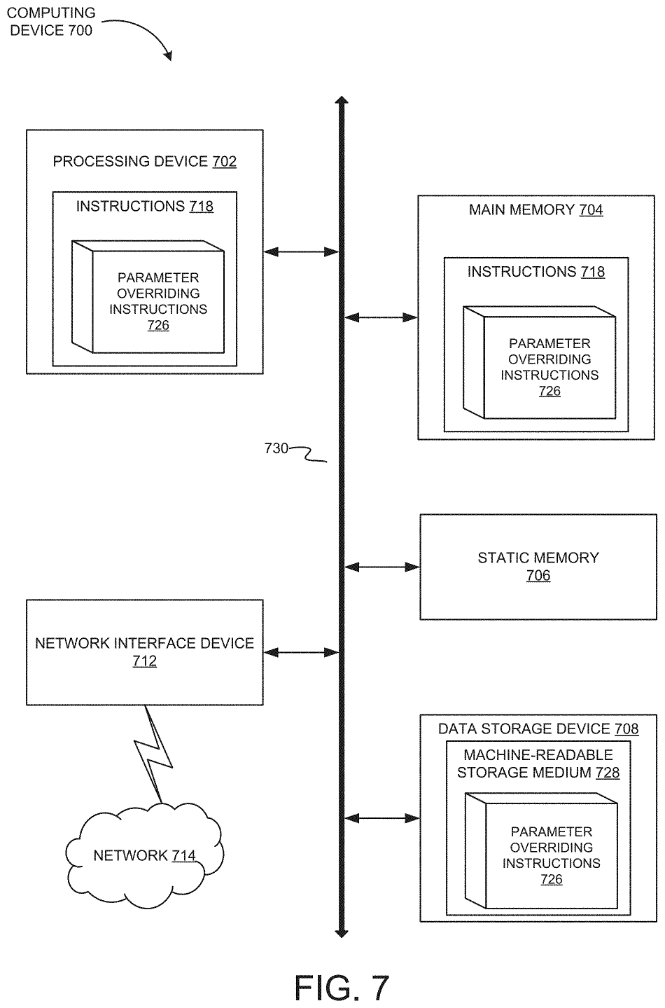

FIG. 7 is a block diagram of an example computing device 700 that may perform one or more of the operations described herein, in accordance with the present embodiments. The computing device 700 may be connected to other computing devices in a LAN, an intranet, an extranet, and/or the Internet. The computing device 700 may operate in the capacity of a server machine in client-server network environment or in the capacity of a client in a peer-to-peer network environment. The computing device 700 may be provided by a personal computer (PC), a set-top box (STB), a server, a network router, switch or bridge, or any machine capable of executing a set of instructions (sequential or otherwise) that specify actions to be taken by that machine. Further, while only a single computing device 700 is illustrated, the term “computing device” shall also be taken to include any collection of computing devices that individually or jointly execute a set (or multiple sets) of instructions to perform the methods discussed herein.

The example computing device 700 may include a computer processing device (e.g., a general purpose processor, ASIC, etc.) 702, a main memory 704, a static memory 706 (e.g., flash memory and a data storage device 708), which may communicate with each other via a bus 730. The computer processing device 702 may be provided by one or more general-purpose processing devices such as a microprocessor, central processing unit, or the like. In an illustrative example, computer processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 702 may also comprise one or more special-purpose processing devices such as an application specific integrated circuit (ASIC), a field programmable gate array (FPGA), a digital signal processor (DSP), network processor, or the like. The computer processing device 702 may be configured to execute the operations described herein, in accordance with one or more aspects of the present disclosure, for performing the operations and steps discussed herein.

The computing device 700 may further include a network interface device 712, which may communicate with a network 714. The data storage device 708 may include a machine-readable storage medium 728 on which may be stored one or more sets of instructions, e.g., instructions for carrying out the operations described herein, in accordance with one or more aspects of the present disclosure. Instructions 718 implementing parameter overriding instructions 726 may also reside, completely or at least partially, within main memory 704 and/or within computer processing device 702 during execution thereof by the computing device 700, main memory 704 and computer processing device 702 also constituting computer-readable media. The instructions may further be transmitted or received over the network 714 via the network interface device 712.

While machine-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry,

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination,

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
receiving override parameters for one or more of default parameters of a virtual entity;
applying, by a computer processing device, the override parameters to the one or more default parameters to generate a modified virtual entity; and
causing the modified virtual entity to be instantiated in one or more client applications while the one or more client applications are running.

2. The method of claim 1, wherein the override parameters are applied to the one or more default parameters without modifying underlying code of the one or more client applications.

3. The method of claim 1, further comprising:
generating a graphical user interface (GUI) comprising the default parameters of the virtual entity; and
receiving, via the GUI, the override parameters for the one or more of the default parameters.

4. The method of claim 1, wherein the one or more client applications comprise a first client application using a first programming language and a second client application using a second programming language.

5. The method of claim 1, further comprising:
receiving the default parameters of the virtual entity; and
storing the default parameters of the virtual entity in a data structure.

6. The method of claim 5, wherein the data structure comprises a plurality of default parameters for a plurality of virtual entities.

7. The method of claim 6, further comprising:
receiving a query comprising one or more search criteria;
identifying one or more of the plurality of virtual entities of the data structure that satisfy the one or more search criteria; and
generating results of the query comprising the one or more of the plurality of virtual entities.

8. The method of claim 5, further comprising:
storing the override parameters associated with the modified virtual entity in the data structure.

9. A system, comprising:
a memory; and
a computer processing device, operatively coupled to the memory, to:
receive override parameters for one or more of default parameters of a virtual entity;
apply the override parameters to the one or more default parameters to generate a modified virtual entity; and
cause the modified virtual entity to be instantiated in one or more client applications while the one or more client applications are running.

10. The system of claim 9, wherein the override parameters are applied to the one or more default parameters without modifying underlying code of the one or more client applications.

11. The system of claim 9, wherein the computer processing device is further to:
generate a graphical user interface (GUI) comprising the default parameters of the virtual entity; and
receive, via the GUI, the override parameters for the one or more of the default parameters.

12. The system of claim 9, wherein the one or more client applications comprise a first client application using a first programming language and a second client application using a second programming language.

13. The system of claim 9, wherein the computer processing device is further to:
receive the default parameters of the virtual entity; and
store the default parameters of the virtual entity in a data structure.

14. The system of claim 13, wherein the data structure comprises a plurality of default parameters for a plurality of virtual entities.

15. The system of claim 14, wherein the computer processing device is further to:
receiving a query comprising one or more search criteria;
identifying one or more of the plurality of virtual entities of the data structure that satisfy the one or more search criteria; and
generating results of the query comprising the one or more of the plurality of virtual entities.

16. The system of claim 13, wherein the data structure comprises a key value store.

17. A non-transitory computer-readable medium having instructions stored thereon that, when executed by a computer processing device, cause the computer processing device to:
receive override parameters for one or more of default parameters of a virtual entity;
apply, by the computer processing device, the override parameters to the one or more default parameters to generate a modified virtual entity; and
cause the modified virtual entity to be instantiated in one or more client applications while the one or more client applications are running.

18. The non-transitory computer-readable medium of claim 17, wherein the override parameters are applied to the one or more default parameters without modifying underlying code of the one or more client applications.

19. The non-transitory computer-readable medium of claim 17, wherein the computer processing device is further to:
generate a graphical user interface (GUI) comprising the default parameters of the virtual entity; and
receive, via the GUI, the override parameters for the one or more of the default parameters.

20. The non-transitory computer-readable medium of claim 17, wherein the one or more client applications comprise a first client application using a first programming language and a second client application using a second programming language.
